(19) United States
(12) Patent Application Publication
(10) Pub. No.: US 2008/0129882 A1
(43) Pub. Date: Jun. 5, 2008

(54) DATA TRANSFER DEVICE AND TRANSFER CONTROL METHOD

(76) Inventors: Eiichi MORIYAMA, Osaka (JP); Kiyotaka Iwamoto, Kyoto (JP)

Correspondence Address: MCDERMOTT WILL & EMERY LLP, 600 13TH STREET, NW, WASHINGTON, DC, 20005-3096, US

(21) Appl. No.: 11/947,366

(22) Filed: Nov. 29, 2007

(30) Foreign Application Priority Data
Nov. 30, 2006 (JP) 2006-323403
Oct. 26, 2007 (JP) 2007-278442

(51) Int. Cl. H04N 5/38

(52) U.S. Cl. 348/723; 348/E05.093

(57) ABSTRACT

A video/audio transmitting device according to the present invention comprises a transmitter, a controller for controlling the transmitter, and a plurality of memory elements, wherein the transmitter comprises a video/audio transmitter for transmitting a video/audio signal to a receiving device outside and a device information obtaining unit for receiving from the receiving device device information including information relating to a receiving function of the receiving device and transmitting the received information to the controller. The plurality of memory elements temporarily stores therein the device information. The controller performs parallel processing of writing the device information in at least one of the plurality of memory elements and reading the device information from at least one of the other memory elements and controls the transmitter based on the device information sequentially read from the plurality of memory elements in the parallel processing.

### BACKGROUND OF THE INVENTION

1. Field of the Invention

The present invention relates to a data transfer device and a data transfer control method, more particularly to a device for obtaining and transferring information relating to a receiving device.

2. Description of the Related Art

In recent years, the HDMI (High-Definition Multimedia Interface) communication is adopted in order to transmit video data and audio data from a transmitting device, examples of which are a DVD player and a DVD recorder, to a receiving device, examples of which are a digital television and an amplifier. The transmitting device, when it is sensed that the receiving device is connected thereto via a HDMI cable, retrieves the data structure called EDID (Extended Display Identification Data) in which performance specific to each receiving device (including information relating to a receiving function) and characteristic data are recorded via the DDC (Display Data Channel) communication from the device on the other side (receiving device) to thereby confirm the performance of the device on the other side, and then, transmits the video data and the audio data suitable for the device on the other side connected thereto.

FIG. 2 shows a transfer flow of the EDID transmitted from the receiving device to the transmitting device according to the conventional technology. A transmitting device 201 comprises a system computer 203 and an HDMI-transmitting LSI 202 for controlling the transmission of the video and audio data. The HDMI-transmitting LSI 202 comprises a video/audio transmitter 205 for transmitting the video and audio data and a DDC buffer 204 which is a region where the information obtained via the DDC communication is stored.

The system computer 203 is connected to the DDC buffer 204 and the video/audio transmitter 205 via an I²C (inter-Integrated Circuit) bus 211. The I²C bus 211 is an interface capable of performing the communication between a plurality of devices using only two signal wires which are a serial clock and serial data. The I²C bus 211 has such a simple structure that it is widely used for internal controls in a television and a DVD reproducing device.

A receiving device 206 comprises an EDID region 207 in which the EDID is stored, a device information transmitter 208 for controlling the EDID transmission, and a video/audio processor 209 for processing the video and audio data.

The transmitting device 201 and the receiving device 206 are connected to each other via an HDMI cable 210. In the receiving device 206, the EDID is read from the EDID region 207 and transmitted to the transmitting device 201 via a DDC (Display Data Channel) bus 220 included in a part of the HDMI cable. In the transmitting device 201, the received EDID is stored in the DDC buffer 204 inside the HDMI-transmitting LSI 202. The EDID stored in the DDC buffer 204 is transferred to the system computer 203 via the I²C bus 211. The system computer 203 analyzes the EDID transferred thereto. Further, the system computer 203 generates video and audio data suitable for the receiving device 206 based on a result of the analysis, and transmits the generated video and audio data from the video/audio transmitter 205 to the receiving device 206 via the HDMI cable. The receiving device 206 processes the video and audio data transmitted thereto using the video/audio processor 209 to thereby output the image and sound/voice.

At the time of transmitting the video and audio data, the transmitting device 201 obtains the EDID information of the receiving device 206 before the transmission of contents in order to obtain the video and audio information which can be received by the receiving device 206. The EDID information is obtained via the DDC communication. The transmitting device 201 requests an address designated by the EDID Standard (VESA ENHANCED EXTENDED DISPLAY IDENTIFICATION DATA STANDARD) to read the EDID information. 128-byte-unit blocks constitute the EDID information, and the combination of a plurality of blocks represents the information of the receiving device.

However, in the DDC communication used to obtain the device information of the receiving device, the transfer speed is low. Therefore, in such a system configuration as needs to read a plurality of blocks, the information cannot be efficiently obtained in the case where the receive buffer which stores therein the DDC information secured in the system has a small capacity, which unfavorably increases a processing time.

Further, the EDID information is read from the DDC buffer and then analyzed. Therefore, in such a system configuration as needs to transfer the EDID information to a RAM region in the system using the I²C bus 211, an amount of time necessary for the transfer via the I²C bus 211 is added to the processing time.

Based on the foregoing reasons, in the before-mentioned system configurations, the amount of time necessary for processing the EDID information is extended, which consequently unfavorably generates a time delay in the output of the image and sound/voice in the system.

An example of the conventional technology for solving the problem is recited in No. 2005-130520 of the Japanese Patent Laid-Open, wherein a plurality of buffers are retained in the system so that the EDID information will be controlled in order to overcome the disadvantage. However, the EDID information is distributed and stored in a plurality of blocks, and thus the image and audio output is delayed after all because the processing is overloaded when all of the EDID information is read, and the device information of the receiving device is thereafter analyzed. Further, when it is not possible to secure the sufficient capacity of the DDC buffer 204 in the system shown in FIG. 2, it becomes necessary to read the EDID information of the plurality of blocks at several different times. Accordingly, it becomes necessary to transfer the EDID information already obtained in the DDC buffer 204 to a different region of the system in order to further obtain the EDID information. As a result, it is even more time-consuming to obtain the EDID information.

### SUMMARY OF THE INVENTION

Therefore, a main object of the present invention is to realize the reduction of an amount of time required for obtaining the device information.

In order to achieve the foregoing object, in the present invention, two buffers are prepared, and the device information (EDID) transferred from a receiving device is stored therein. Then, the data transfer from the receiving device to a transmitting device and the data transfer from the transmitting device to a controller (system computer) are subjected to parallel processing. Accordingly, the amount of time required for obtaining the device information can be reduced.

In order to read the device information from the receiving device via the DDC bus, a slave address and an offset address, in which the device information desired to be obtained is stored, are transmitted, and the device information transmitted from the receiving device is allocated to and stored in the plurality of memory elements (buffers). Further, a control register capable of writing the device information in the memory elements using hardware is provided, and bits are set in the control register by the controller. Accordingly, the obtained device information obtained by such bit setting is allocated to and stored in the plurality of memory elements.

In order to perform parallel processing under the foregoing constitution, a processing order is controlled so that when the data stored in at least one of the plurality of memory elements is read and transferred to the controller, the device information obtained from the receiving device is written in at least one of the other memory elements, and when the data stored in the at least such one of the other memory elements as described above is read and transferred to the controller, the device information obtained from the receiving device is written in at least such one of the plurality of memory elements described above. When the processing order is thus controlled, the data transfer from the receiving device to the transmitting device and the data transfer from the transmitting device to the controller can be subjected to parallel processing.

When an error arises in the DC communication because the transmitting device accesses the region where the data is not stored via the DDC communication in the process of obtaining the device information, a factor of the error is investigated so as to judge if the error arose on the DDC communication or the error results from the access made to the region where the data is not stored (address error). Then, appropriate processing is selected in the system based on the judgment so that the error is processed if it arose on the DDC communication, and the normal processing is continued if it was the address error.

In order to avoid the error in the DDC communication due to the access with respect to the region where the data is not stored in the receiving device, in the present invention, device information, by which the presence or absence and position of the region where the data is not stored can be confirmed, is obtained from the receiving device in advance. Then, the controller controls a device information obtaining unit so that the region where the data is not stored is not accessed to obtain the device information, based on the obtained device information which allows the non-data region to be confirmed.

In the present invention thus constituted, the device information can be speedily and accurately obtained, while the error caused during the DDC communication between the transmitting and receiving devices is being analyzed at the same time.

The data transfer device and the data transfer control method according to the present invention is effectively applied to the improvement in processing speed when device information is transferred from a receiving device to a controller provided in a transmitting device in a system for transmitting video and audio data to the receiving device using the HDMI, examples of which are a DVD player and a DVD recorder.

### BRIEF DESCRIPTION OF THE DRAWINGS

These and other objects of the invention will become clear by the following description of preferred embodiments of the invention and are specified in the claims attached hereto. A number of benefits not recited in this specification will come to the attention of the skilled in the art upon the implementation of the present invention.

FIG. 1 shows a configuration of a system for transferring data according to a preferred embodiment of the present invention.

FIG. 2 shows a configuration of a conventional system for transferring data.

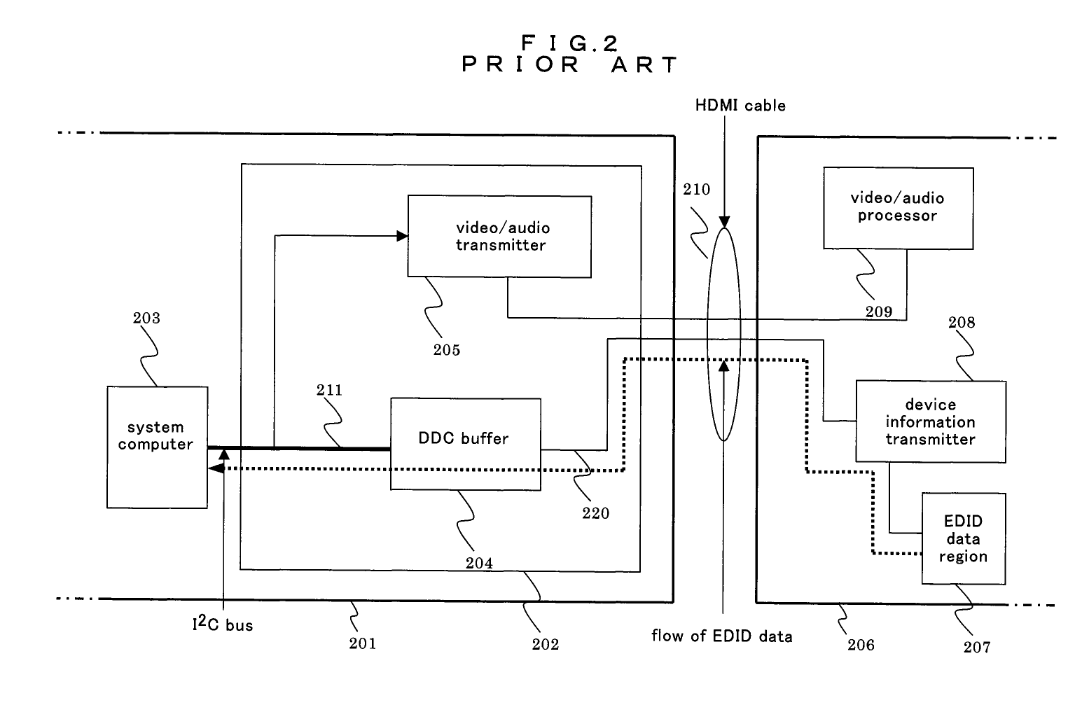

FIG. 3 shows an order of data transfer control according to the present invention.

FIG. 4 is a normal processing flow chart which illustrates data transfer control in a controller according to the present invention.

FIG. 5 is a schematic view showing three structural patterns of the EDID.

FIG. 6 is an error-based processing flow chart in a system comprising only a base block.

FIG. 7 is a flow chart for realizing time reduction by avoiding any access to non-existent EDID region and adopting parallel processing.

FIG. 8 is a drawing which shows minimum structural components as a device according the present invention.

FIG. 9 is a drawing showing structural components for obtaining video and audio data to be transmitted, which are added to the present invention.

### DETAILED DESCRIPTION OF THE INVENTION

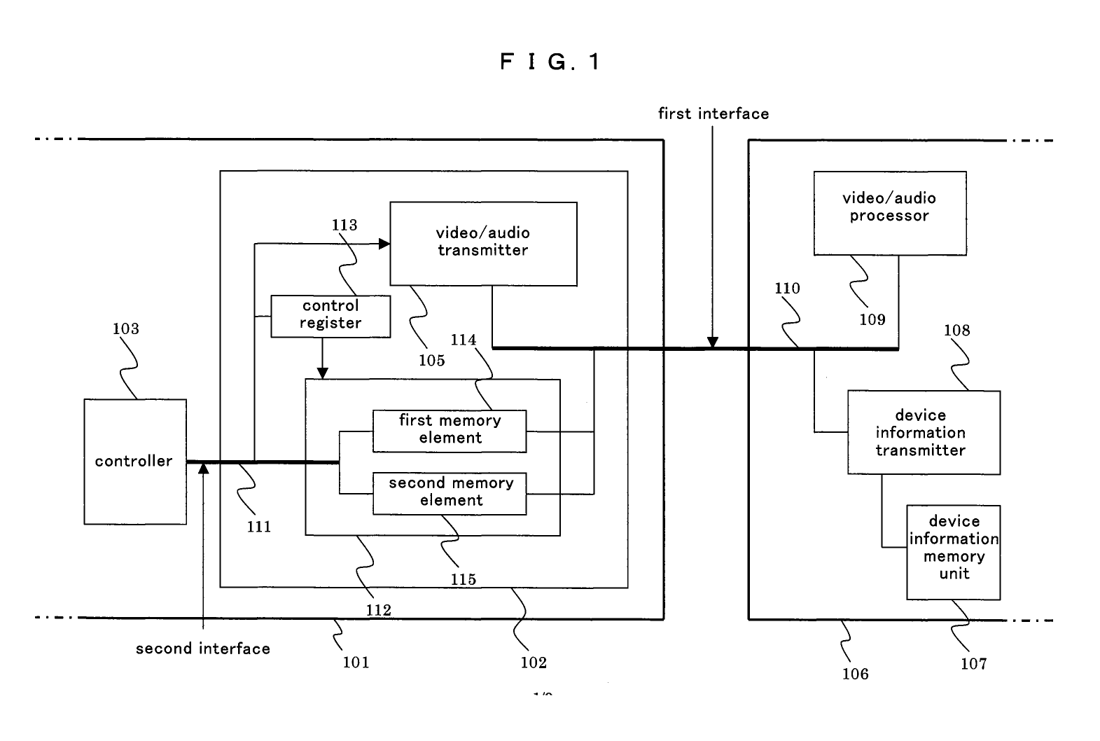

Hereinafter, a preferred embodiment of a data transfer device and a data transfer control method according to the present invention is described in detail referring to the drawings. FIG. 1 shows a state where a video/audio transmitting device 101, such as a DVD player or a DVD recorder, and a receiving device 106, such as a digital television or an AV amplifier, are connected to each other via a first interface 110 (HDMI).

The video/audio transmitting device 101 comprises a controller (microcomputer or the like) 103 for controlling a system and a transmitter 102 for controlling video and audio data to be transmitted. The transmitter 102 comprises a video/audio transmitter 105, a device information obtaining unit 112, and a control register 113.

The video/audio transmitter 105 plays a role as a TDMS transmitter for halting and starting the transmission of the video and audio data using the transmission method called TMDS (Transition Minimized Differential Signaling). The device information obtaining unit 112 plays a role as a DDC input/output controller for obtaining the device information (including information relating to a receiving function) of a device on the other side such as the EDID via a DDC (Display Data Channel) bus which is a part of the first interface 110. The control register 113 controls the device information obtaining unit 112.

The device information obtaining unit 112 comprises a first memory element 114 and a second memory element 115. These memory elements 114 and 115 are buffers in which data obtained from the DDC bus is stored. The minimum number of the memory elements 114 and 115 is two; however, more than two memory elements may be provided. Further, the memory elements 114 and 115 may not be necessarily provided inside the transmitter, and may be provided in any region where the data can be stored by the device information obtaining unit 112 and the system is accessible. A size of the memory elements 114 and 115 may not be necessarily limited; however, the data can be easily handled if they have the size of 128 bytes which is a minimum unit of the EDID structure.

The controller 103 is connected to the video/audio transmitter 105 and the control register 113 via an I²C bus which is a second interface 111, and controls these components. The controller 103 is further connected to the first memory element 114 and the second memory element 115 so that the data is communicated between these memory elements. The receiving device 106 comprises a device information memory unit 107 in which the device information such as the EDID is stored, a device information transmitter 108 for controlling the transmission of the device information, and a video/audio processor 109 for processing the video and audio data.

A segment pointer is used to access the EDID. When a value (0-127) of a segment (data unit segmented by 256 bites of the EDID) which is desired to be read is written at 60h of DDC addresses, A0h and A1h of the DDC addresses become equivalent to the segment, which allows the data to be read. The mechanism of this reading operation is regulated by the ENHANCED DISPLAY DATA CHANNEL STANDARD based on the VESA (Video Electronics Standards Association). The controller 103 sets the following information in the control register 113. The controller 103 sets the value of the segment which is desired to be read (example: 0x00 in the case of the leading segment), size of the data to be read (example: 0x7F in the case of 128 bytes), information for identifying which of A0h and A1h is to be accessed, and information for identifying in which of the first memory element 114 and the second memory element 115 the data obtained via the DDC communication is stored (example: 0x00 in the case where the data at A0h is stored in the first memory element 114, 0x80 in the case where the data at A0h is stored in the second memory element 115, 0x08 in the case where the data at A1h is stored in the first memory element 114, and 0x88 in the case where the data at A1h is stored in the second memory element 115), in the control register 113.

After the information is set as above, the controller 103 issues a command for executing the contents which were set. Hereinafter, the processing for obtaining the device information (EDID) of the receiving device 106 by setting the information in the control register 113 and issuing the command is referred to as an EDID read command issuance. A similar processing can be executed in such a constitution that the address where the device information of the device on the other side is stored is directly designated without using the segment pointer.

When the foregoing setting is completed in the control register 113, the device information obtaining unit 112 transmits a clock signal for reading the device information to the device information transmitter 108 inside the receiving device 106 via the DDC bus. The signal conforms to the I²C specification and includes a slave address and an offset address of the device information (EDID) which is desired to be read. The device information transmitter 108 transmits the device information (EDID) in the device information memory unit 107 to the device information obtaining unit 112 as requested by the signal. The device information obtaining unit 112 stores the transmitted EDID in the first memory element 114 or the second memory element 115 in accordance with the setting of the control register 113. The controller 103 reads the EDID stored in the first memory element 114 or the second memory element 115 via the I²C bus 111. A series of processing described above is repeated so that the device information of the receiving device 106 is transmitted to the controller 103 of the video/audio transmitting device 101.

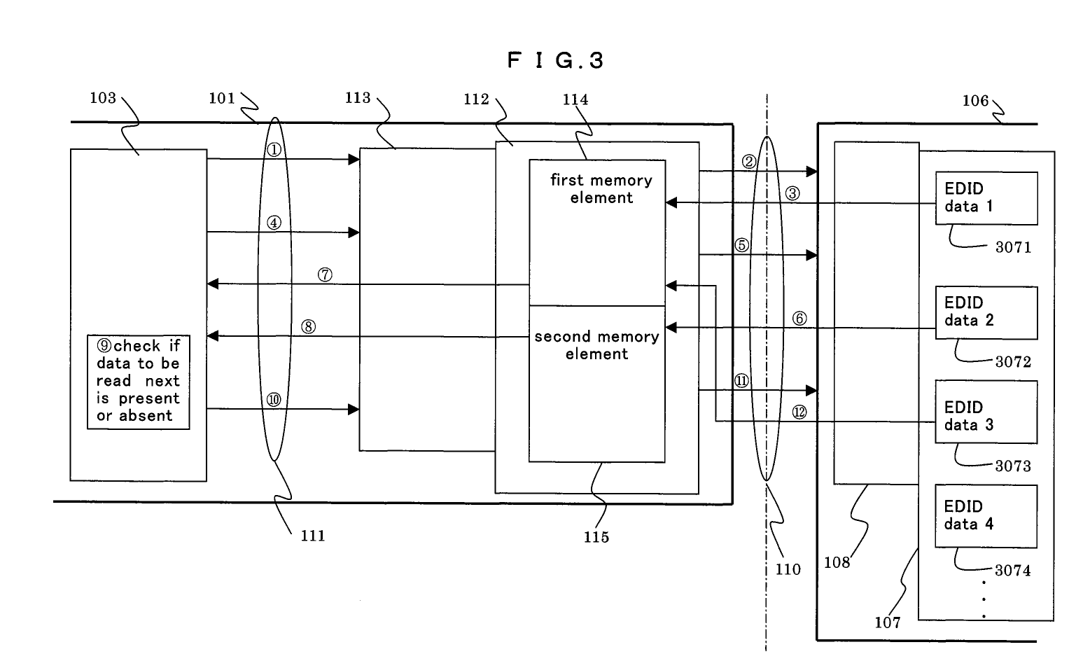

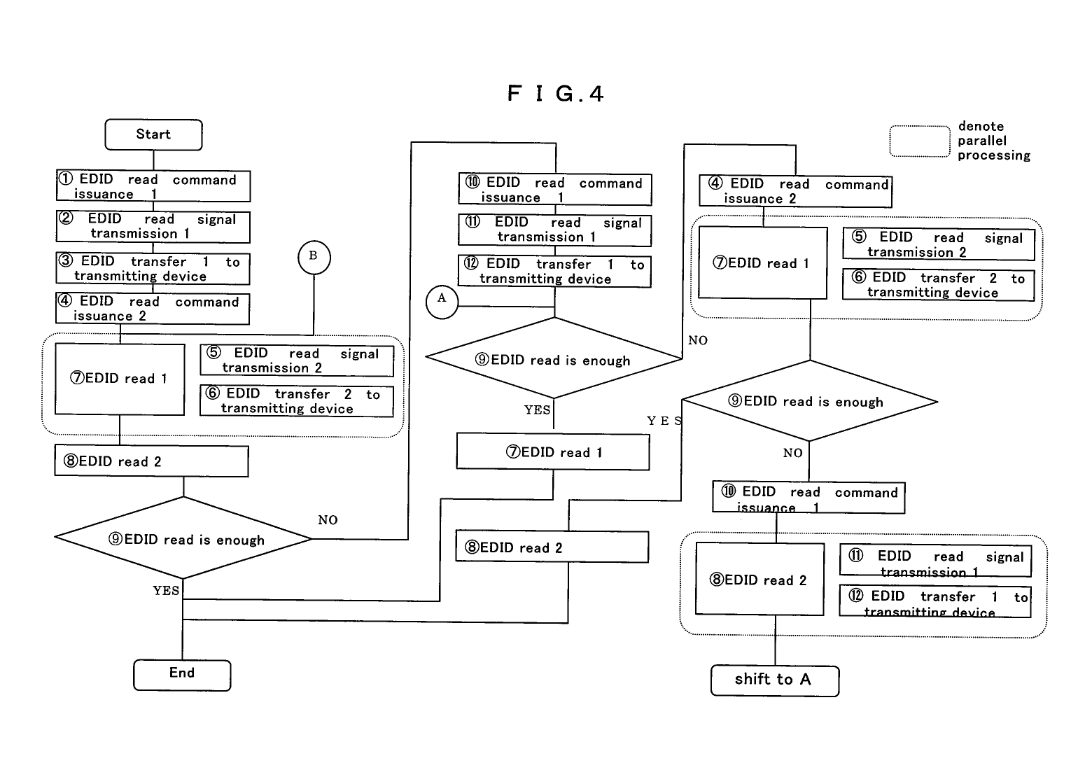

Below are described referring to the drawings processing steps in which the two memory elements 114 and 115 are alternately used so that an amount of time for reading the EDID from the receiving device 106 and transmitting the read EDID to the controller 103 is reduced. In FIG. 3, processing steps when the EDID is read are shown with number-attached arrows. FIG. 4 is a flow chart illustrating processing steps of the data transfer in the controller. The processing numbers 1-12 shown in FIG. 4 correspond to the processing numbers shown in FIG. 3.

The controller 103 issues the EDID read command for reading EDID data 1 (3071), which is one of the device information, from the first memory element 114 to the control register 113 via the I²C bus 111 (processing number 1). The size of the device information read at one time is set to 128 bytes which is the minimum unit of the data structure.

When the EDID read command is issued to the control register 113, the device information obtaining unit 112 immediately transmits a signal for reading the EDID data 1 (3071) to the receiving device 106 via the DDC bus (processing number 2). The receiving device which received the signal starts to transmit the EDID data 1 (3071) from the device information transmitter 108 to the video/audio transmitting device 101. The device information obtaining unit 112 stores the transmitted EDID data 1 (3071) in the first memory element 114 (processing number 3).

When the storage of the EDID data 1 (3071) in the first memory element 114 is completed, the controller 103 issues the EDID read command relating to EDID data 2 (3072), which is the device information to be subsequently read, to the control register 113 (processing number 4). When the EDID read command for obtaining the EDID data 2 (3072) is issued, the EDID data 1 (3071) stored in the first memory element 114 is immediately read and transmitted to the controller 103 (processing number 7). Further, when the EDID read command relating to the EDID data 2 (3072) is issued to the control register 113, the device information obtaining unit 112 transmits a signal for reading the EDID data 2 (3072) to the receiving device 106 in parallel with the processing of the processing number 7 (processing number 5). The receiving device 106 which received the signal starts to transmit the EDID data 2 (3072) to the transmitting device 101 via the device information transmitter 108. The transmitting device 101 correspondingly stores the transmitted EDID data 2 (3072) in the second memory element 115 (processing number 6).

Immediately after the processing of the processing number 7 and the processing of the processing numbers 5 and 6 are all completed, the EDID data 2 (3072) is immediately read from the second memory element 115 and transmitted to the controller 103 (processing number 8). Upon the completion of the processing of the processing number 8, all of the EDID stored in the first memory element 114 and the second memory element 115 have been read and transmitted to the controller 103.

The controller 103 confirms the presence or absence of the device information (EDID data) which needs to be read next (processing number 9: details will be described later). In the absence of the device information to be further read as a result of the confirmation, the processing of obtaining the device information is then completed. In the presence of the device information to be further read, the controller 103 issues the EDID read command (command for reading EDID data 3 (3073), which is the device information, from the first memory element 114) to the control register 113 (processing number 10).

When the issuance of the EDID read command to the control register 113 is completed, the device information obtaining unit 112 transmits a signal for reading the EDID data 3 (3073) to the receiving device 106 (processing number 11). The receiving device 106 which received the signal transmits the EDID data 3 (3073) to the transmitting device 101 (processing number 12).

Then, the presence or absence of the device information (EDID data) which needs to be read next is again confirmed (processing number 9), and the EDID data 3 (3073), which is the device information stored in the first memory element 114, is read and transmitted to the controller 103 (processing number 7) in the absence of the device information to be further read. Then, the processing of obtaining the device information is completed.

In the presence of the device information to be further read on the other hand, the controller 103 issues the EDID read command for reading EDID data 4 (3074), which is the device information, from the second memory element 115, to the control register 113 (processing number 4). At the time, the controller 103 writes the EDID data 4 (3074) in the second memory element 115 (processing numbers 5 and 6) and reads the EDID data 3(3073) stored in the first memory element 114 (processing number 7) at the same time. Thereafter, the following processing is alternately executed until it is confirmed that it is no longer necessary to read the device information based on the result of the processing number 9.
the issuance of the EDID read command for using the first memory element 114 to store any odd-numbered device information (EDID data), and
the issuance of the EDID read command for using the second memory element 115 to store any even-numbered device information (EDID data).

Therefore, the EDID is read from the receiving device 106 and transmitted to the transmitting device 101, and the EDID is read from the two memory elements 114 and 115 and transmitted to the controller 103 at the same time in such a manner that the two memory elements 114 and 115 are alternately used. Thereby, the amount of time necessary for transferring the EDID from the receiving device 106 to the controller 103 of the transmitting device 101 can be reduced.

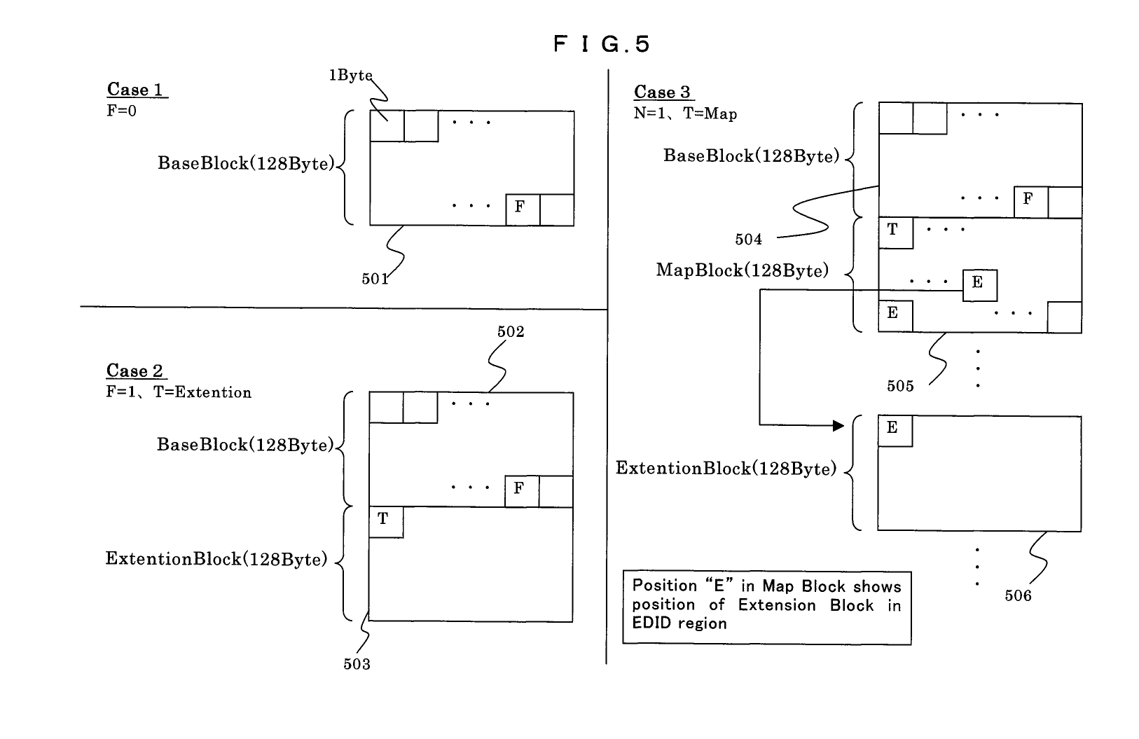

Next, details of the processing of the processing number 9 are further described along with the description of the EDID structure. FIG. 5 shows three patterns of a simplified structure of the device information (EDID). The structure of the device information (EDID) belongs to any of the three patterns. Case 1 is a structure having only a Base Block 501 where an Extension Block 503 is not provided. Case 2 is a structure having a Base Block 502 and an Extension Block 503. Case 3 is a structure having a Base Block 504, a Map Block 505 and an Extension Block 506. The Case 3 is obtained as a result of the extension of the Case 2.

When the processing of the processing numbers 1-8 is executed in the order shown in FIG. 3 to a device where the EDID having the structure of the Case 2 is set, the Base Block 502 corresponding to the EDID data 1 (3071) is stored in the first memory element 114, and the Extension Block 503 corresponding to the EDID data 2 (3072) is stored in the second memory element 115. As a result, the data of the Base Block 502 and the data of the Extension Block 503 have been read into in the controller 103. When 1 byte at the top of the Extension Block 503 is checked in the processing of the processing number 9, it is known that the block is the Extension Block because 1 byte at the top of a block includes a tag which shows the type of the block (“T” shown in FIG. 5) based on the Standard of the device information (EDID) (VESA ENHANCED EXTENDED DISPLAY IDENTIFICATION DATA STANDARD). When it is known that the second block is the Extension Block, it is known that the EDID of this device has the structure of the Case 2. Therefore, the read of the device information is completed without the issuance of the EDID read command for reading the next EDID to the control register 113 (processing number 10).

When the processing of the processing numbers 1-8 is executed to a device where the EDID having the structure of the Case 3 is set, the data of the Base Block 504 and the data of the Map Block 505 have been read into the controller 103. When 1 byte at the top of the Map Block 505 is checked in the processing of the processing number 9, it is known that the block is the Map Block. In the Map Block, a position where the Extension Block 506 is stored is written (“E” shown in FIG. 5) based on the Standard of the device information (EDID) (VESA ENHANCED EXTENDED DISPLAY IDENTIFICATION DATA STANDARD). Therefore, the position where the Extension Block is stored can be identified when the data in the Map Block is checked after the block is known to be the Map Block in the processing of the processing number 9. When the position where the Extension Block is stored and the number thereof are known, the data transfer between the receiving device 106 and the transmitting device 101 and the data transfer between the two memory element 114 and 115 and the controller 103 can be parallelized (loop processing via A shown in FIG. 4) in such a manner that the two memory elements 114 and 115 are alternately used according to the before-mentioned processing steps until the read of as many the found Extension Blocks as necessary is completed.

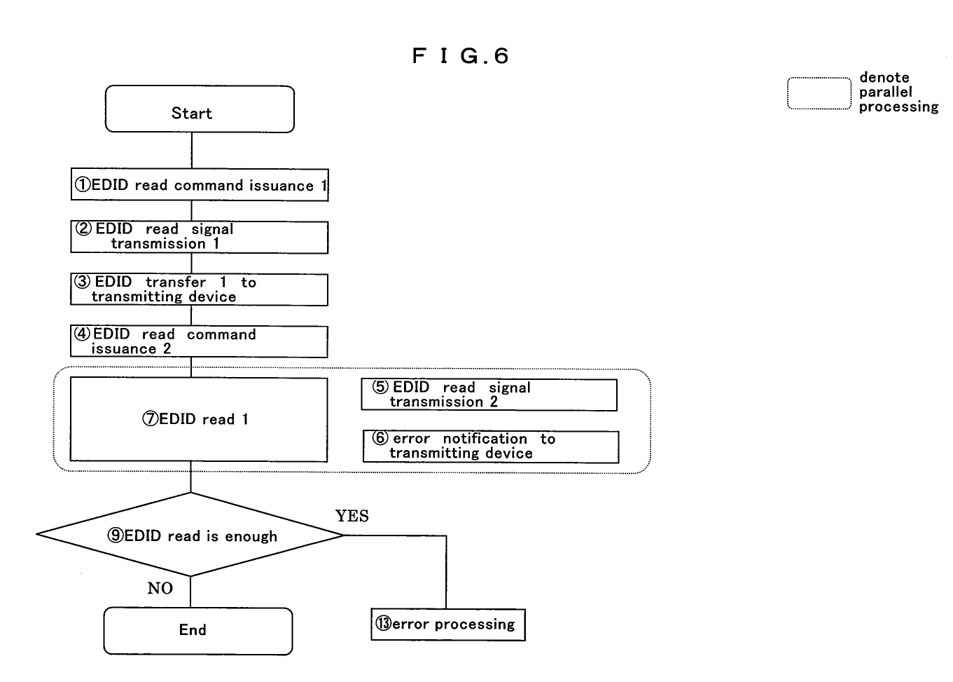

When the processing of the processing numbers 1-4 is executed to a device where the EDID having the structure of the Case 1 is set, the signal which instructs the EDID data 2 to be obtained is transmitted to the receiving device 106 in the processing number 5, in which case, however, the receiving device 106 does not have the EDID corresponding to the EDID data 2 (3072). Therefore, the processing number 6, which is a response from the receiving device 106, is returned as an error (see FIG. 6).

When the EDID read command is issued to the receiving device in which the EDID not having the Extension Block is set in order to read the Extension Block (processing number 4 shown in FIG. 6), the DDC communication is performed with respect to an offset address which does not exist. It is regulated by the Standard that, in the DDC communication, the communication is performed in a protocol similar to that of the I²C communication, and an acknowledgement that the communication is terminated is returned from the other party to which the communication was made when the communication is normally terminated. Therefore, when an access is made to any offset address region which does not exist, the acknowledgement is not returned, and the DDC communication results in an error (processing number 6 shown in FIG. 6). At the time, the transmitting device 101 concurrently reads the Base Block 501 stored in the first memory element 114 into the controller 103 (processing number 7 shown in FIG. 6). At the moment, it is not possible for the transmitting device 101 (controller 103) to judge if the error returned from the receiving device 106 accidentally arose in the DDC communication or was caused by the access made to the non-existent EDID.

Then, the controller 103 checks 1-byte data of the 127th byte (“F” shown in FIG. 5) in the Base Block 501 when the read of the Base Block 501 is completed. The 1-byte data is called Extension Flag, in which information on the presence or absence of the Extension Block and the Map Block is written. According to the EDID Standard (VESA ENHANCED EXTENDED DISPLAY IDENTIFICATION DATA STANDARD), 0x01 is written in the Extension Flag in the presence of the Extension Block and the Map Block, while 0x00 is written therein in the absence of the Extension Block and the Map Block. Therefore, when the value of the Extension Flag is 0x01, it is denoted that the response showing the DDC error was returned though the Extension Block and the Map Block are present. The controller 103 detects the returned response, and judges that the current status reflected the accidental error in the DDC communication (processing number 9 shown in FIG. 6). In this case, the controller 103 shifts to the error-based processing of the system, and retries the communication (processing number 13 shown in FIG. 6).

When the value of the Extension Flag is 0x00, it is denoted that the Extension Block and the Map Block do not exist, and the error in the DC communication arose because the non-existent EDID region was accessed. The controller 103 detects the fact, and does not perform error processing based on the judgment that the receiving device is of the EDID structure of the Case 1 having only the Base Block. Then, the controller 103 obtains the EDID in the processing numbers 1-7 shown in FIG. 6 and thereafter stops to obtain the EDID.

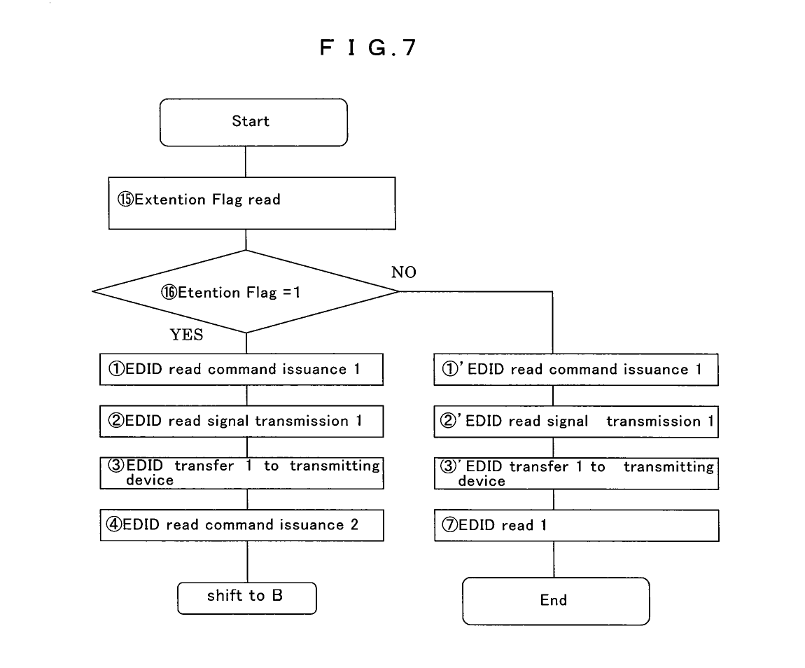

Next is described how to avoid the DDC error due to the absence of the Extension Block and the Map Block (see FIG. 7). First, the controller 103 reads the 1-byte data of the Extension Flag (processing number 15 shown in FIG. 7), and confirms the presence or absence of the Extension Block and the Map Block (processing number 16 shown in FIG. 7). When it is judged that the Extension Block and the Map Block are present, the controller 103 continuously issues the EDID read command (processing numbers 1-4 shown in FIG. 7) to thereby sequentially read the Base Block and the Extension Block. When it is judged that the Extension Block is absent, the controller 103 changes the method of issuing the command so that only the Base Block is read (processing numbers 1′, 2′, 3′ and 7 shown in FIG. 7). It is thereby avoided to access the non-existent Extension Block and Map Block.

The two different methods of issuing the command as described above are provided so that the error caused in the DDC communication resulting from the access with respect to the non-existent EDID can be avoided. Further, in the case where the Extension Block and the Map Block are present, the processing can be parallelized in such a manner that the EDID read command is continuously issued as shown in the processing numbers 5, 6 and 7. As a result, the device information (EDID) can be efficiently obtained.

When the processing is executed in the described order depending on the three EDID structural patterns, the data transfer between the receiving device 106 and the transmitting device 101 and the data transfer between the two memory elements 114 and 115 and the controller 103 can be parallelized. As a result, the amount of time necessary for the transmission of the device information (EDID) to the controller 103 can be reduced. The amount of time thereby reducible depends on the structure of the device information (EDID) of the connected device on the other side. However, the amount of time can be reduced by [time for transferring 128-byte data between the receiving device 106 and the transmitting device 101]×[number of blocks to be read] because the data can be transferred between the receiving device 106 and the transmitting device 101 in parallel with the data transfer between the two memory elements 114 and 115 and the controller 103.

In the case where the Extension Flag is first read as one of methods and the size of one memory element is set to 256 bytes, the EDID read command can be less frequently issued. As a result, a processing speed can be increased. When the Extension Flag shows 0x01, the Extension Block inevitably exists. Therefore, the size of the data to be read is set to 256 bytes and the EDID read command is issued once if the size of the memory elements 114 and 115 is 256 bytes. As a result, the Base Block, Extension Block and Map Block can be easily obtained. Further, because the data of up to 256 bytes can be obtained at one time even in the case where a plurality of Extension Blocks are present, the data having the same size can be obtained when the command is issued ½ as many times as in the case where the size of the memory elements 114 and 115 is 128 bytes. As a possible option in the case where the detected Extension Flag shows 0x00, the size of the data to be read is changed to 128 bytes so as to avoid any unnecessary access to the data region where the Extension Block and the Map Block do not exist, and then, the EDID read command is issued so that only the Base Block is obtained.

In the case where the area of the memory element which can be prepared is limited (for example, if only one buffer of 128 bytes can be provided), the data obtained at one time may be reduced to a half. Accordingly, when processing similar to that in the case where there are two memory elements each having the size of 128 bytes, the data transfer between the receiving device 106 and the memory elements 114 and 115 and the data transfer between the two memory elements 114 and 115 and the controller 103 can be parallelized. If it is possible to finely manage the obtained data in the foregoing case, the size of the data obtain able at one time may be set to 1 byte so that the data is concurrently transferred by 1 byte.

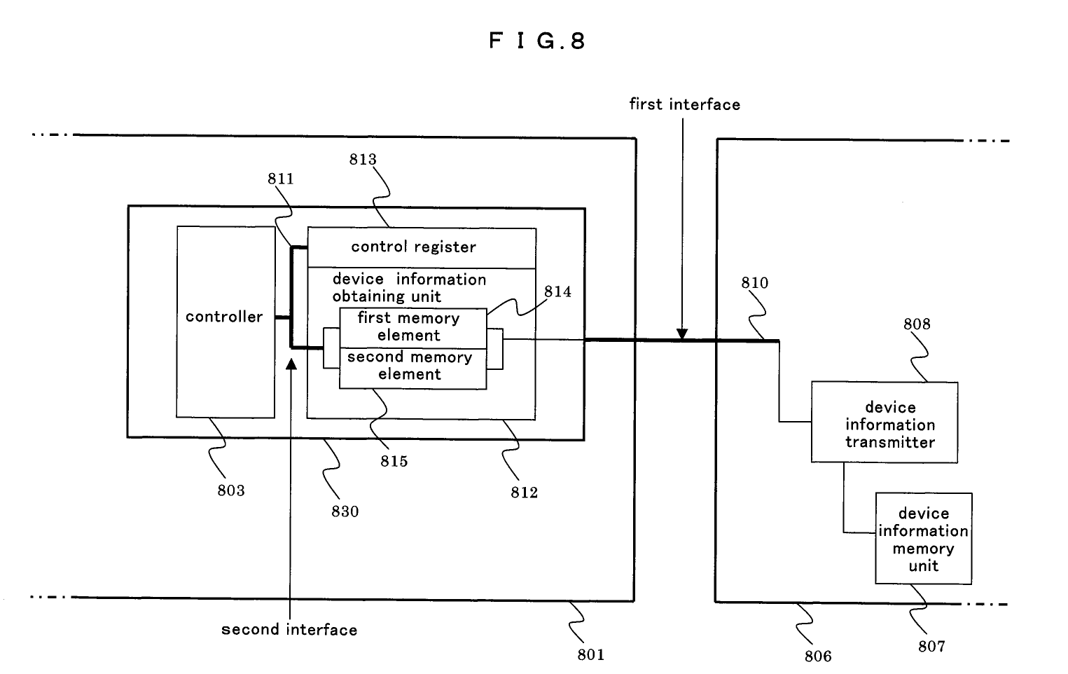

It is not always necessary to provide the device information obtaining unit 12, first and second memory elements 114 and 115 and control register 113 inside the transmitter 102. As shown in FIG. 8, a controller 803, a device information obtaining unit 812, a control register 813, and first and second memory elements 814 and 815 may constitute a control device (device information obtaining device 830).

The first memory element 114 and the second memory element 115 are not necessarily physically separated, and two memory elements may be virtually provided in such a manner that different addresses are given to access one memory element. In this case, the memory element can be divided based on any arbitrary rate and into any arbitrary numbers of portions. Therefore, the data region stored in the memory element can be changed depending on the data size of the device information (EDID) to be obtained, and the memory element region can be used based on an optimum size suitable for the data size.

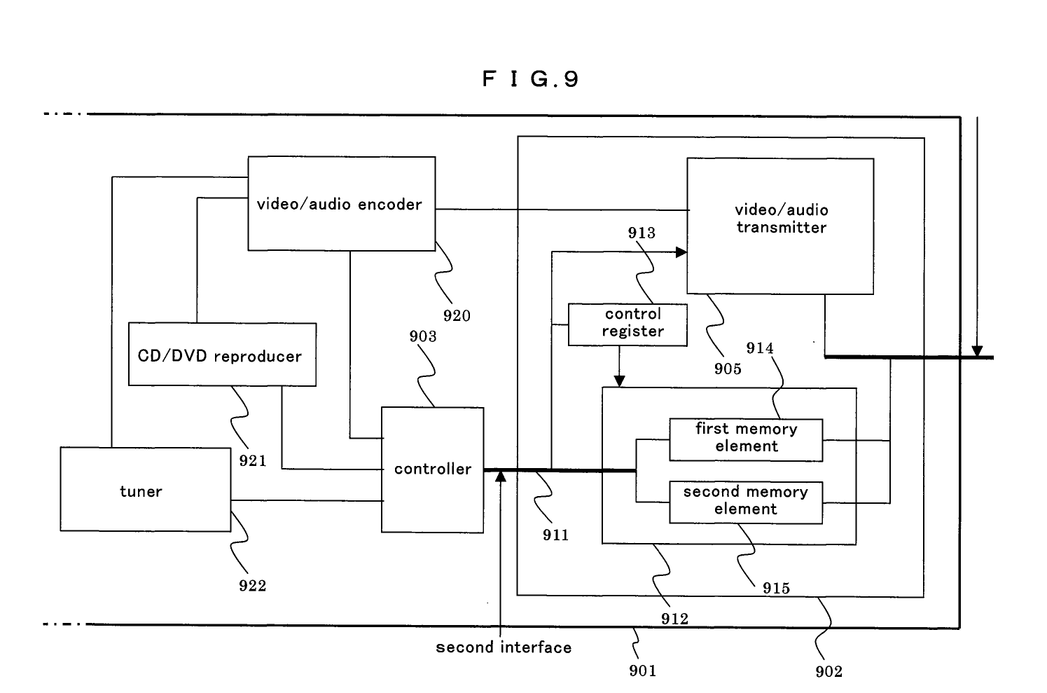

Further, as shown in FIG. 9, the video/audio transmitting device (see FIG. 1) may further comprise a CD/DVD reproducer 921 for reading data from a medium such as CD or DVD, a tuner 922 for receiving video and audio data from outside, and a video/audio encoder 920 for encoding the video and audio data. Accordingly, a controller 903 can transmit the data of the CD and DVD and the data obtained in the terrestrial digital broadcast in the form of a signal suitable for the performance of the connected device on the other side based on the device information of the device on the other side obtained by the device information obtaining unit (see FIG. 9).

As thus far described, according to the preferred embodiment, the device information of the connected device on the other side can be more speedily read, and the video and audio data can be more speedily outputted after power is supplied to the video/audio transmitting device such as a DVD player or a DVD recorder. As a result, the amount of time necessary for outputting the video and audio data on the connected device on the other side can be effectively shortened.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A video/audio transmitting device comprising:
a transmitter;
a controller for controlling the transmitter; and
a plurality of memory elements, wherein
the transmitter comprises:
a video/audio transmitter for transmitting a video/audio signal to a receiving device outside; and
a device information obtaining unit for receiving from the receiving device device information including information relating to a receiving function of the receiving device and transmitting the received device information to the controller, and the plurality of memory elements temporarily stores therein the device information,
the controller performs parallel processing of writing the device information in at least one of the plurality of memory elements and reading the device information from at least one of the other memory elements, and controls the transmitter based on the device information sequentially read from the plurality of memory elements in the parallel processing.

2. The video/audio transmitting device as claimed in claim 1, wherein
an interface for connecting the receiving device and the video/audio transmitter to each other and an interface for connecting the device information obtaining unit and the controller to each other are different to each other.

3. The video/audio transmitting device as claimed in claim 1, further comprising a control register for storing control bits used when the controller controls the device information obtaining unit, wherein
the controller operates the control bits of the control register to thereby select the device information to be received.

4. The video/audio transmitting device as claimed in claim 2, wherein
the controller operates the control bits to thereby select the memory element in which the device information is to be written.

5. The video/audio transmitting device as claimed in claim 1, wherein
the controller writes the device information in at least one of the plurality of memory elements and reads the device information from at least one of the other memory elements in such a manner that the plurality of memory elements are alternately used, and controls the transmitter based on the device information sequentially read from the plurality of memory elements through the alternate control processing.

6. The video/audio transmitting device as claimed in claim 5, wherein
in the case where an error arises when the device information is received, the controller investigates contents of the error from the device information obtained until the error arose and judges if normal processing is continued or error-based processing is selected based on the result of the investigation.

7. The video/audio transmitting device as claimed in claim 5, wherein
the controller reads a data section which can confirm a desired data-stored range from the received device information, confirms the desired data-stored range based on the read data section, selectively reads the confirmed desired data-stored range from the memory element, and transfers the reading result to the controller.

8. A device information obtaining device comprising:
a controller for controlling a transmitter outside; and
a device information obtaining unit for receiving from a receiving device outside device information including information relating to a receiving function of the receiving device and transmitting the received information to the controller, wherein
the device information obtaining unit comprises a plurality of memory elements for temporarily storing the device information, and
the controller performs parallel processing of writing the device information in at least one of the plurality of memory elements and reading the device information from at least one of the other memory elements, and controls the transmitter based on the device information sequentially read from the plurality of memory elements in the parallel processing.

9. The device information obtaining device as claimed in claim 8, further comprising a control register for storing control bits used when the controller controls the device information obtaining unit, wherein
the controller operates the control bits of the control register to thereby select the device information to be received.

10. The device information obtaining device as claimed in claim 8, wherein
the controller writes the device information in at least one of the plurality of memory elements and reads the device information from at least one of the other memory elements in such a manner that the plurality of memory elements are alternately used, and controls the transmitter based on the device information sequentially read from the plurality of memory elements through alternate control processing.

11. The device information obtaining device as claimed in claim 10, wherein
in the case where an error arises when the device information is received, the controller investigates contents of the error from the device information obtained until the error arose, and judges if normal processing is continued or error-based processing is selected based on the result of the investigation.

12. The devise information obtaining device as claimed in claim 10, wherein
the controller reads a data section which can confirm a desired data-stored range from the received device information, confirms the desired data-stored range based on the read data section, selectively reads the confirmed desired data-stored range from the memory element, and transfers the reading result to the controller.

13. A video/audio transmitting device comprising:
the device information obtaining device claimed in claim 8;
a recording medium reproducer for reading video and audio data from a recording medium;
a tuner for receiving the video and audio data; and
a video/audio encoder for encoding the data read by the recording medium reproducer and the video and audio data received by the tuner, wherein
the video and audio data read from the recording medium is transmitted to a receiving device outside based on the device information read from the device information obtaining device.

14. The video/audio transmitting device as claimed in claim 1, wherein
the memory elements are obtained in such a manner that one memory element is virtually divided into a plurality of memory elements.

15. The video/audio transmitting device as claimed in claim 14, wherein
the division rate can be changed in the plurality of memory elements virtually divided.

16. The device information obtaining device as claimed in claim 8, wherein
the memory elements are obtained in such a manner that one memory element is virtually divided into a plurality of memory elements.

17. The device information obtaining device as claimed in claim 16, wherein
the division rate can be changed in the plurality of memory elements virtually divided.
